(19) United States
(12) Patent Application Publication
(10) Pub. No.: US 2020/0018518 A1
(43) Pub. Date: Jan. 16, 2020

(54) Electrical Heating Sleeve for a Combination Backpack and Hydration Pack

(71) Applicant: Anthony L. Policastro, Jersey City, NJ (US)

(72) Inventor: Anthony L. Policastro, Jersey City, NJ (US)

(21) Appl. No.: 16/350,394

(22) Filed: Apr. 14, 2018

(51) Int. Cl. F24H 1/06; H05B 3/14; F24H 1/10; F24H 9/20; H05B 1/02; F24D 17/00; A45F 3/04

(52) U.S. Cl. CPC F24H 1/06; H05B 3/145; F24H 1/105; F24H 9/2028; H05B 1/0297; A45F 2003/001; A45F 3/04; H05B 2203/005; H05B 2203/036; H05B 2203/015; F24D 17/0089

(57) ABSTRACT

A heated sleeve for providing temperature control for a sleeve is disclosed. The sleeve comprises a water-resistant exterior shell; a thermally-insulating interior lining; a micro-controller disposed between the interior lining and the exterior shell; a temperature sensor disposed between the interior lining and the exterior shell and in communication with the micro-controller; a heating element disposed between the interior lining and the exterior shell; and a power source assembly providing power to the micro-controller and to the heating element. Temperature is provided by monitoring temperature of an interior of the sleeve.

### TECHNICAL FIELD

The present invention pertains to a heated sleeve. More particularly, the present invention pertains to a heated sleeve with electronic temperature control.

### BACKGROUND

In active outdoor cold climate activities such as skiing, snowshoeing, and ice climbing; the importance of access to essential life sustaining elements such as water, heat, rest, etc. becomes paramount. There are many options and varieties currently on the market for combination backpack and hydration packs; which all work to a certain extent, but with many options there still lacks complete control and reliability within the system. With todays current constructs, the portion of hydration hose and mouthpiece that exits the bag and bottle cap is left un-insulated. With this being the condition and norm, in many cold climates one experiences freezing and blockages in the line thus making drinking from the pack impossible. In utilizing this sleeve, one mitigates this condition and allows for the pack to be used in cold climates uninhibited. This sleeve looks to be versatile and universal for many existing constructs, closing the gap for a common problem across many retail options.

### SUMMARY OF INVENTION

An accessory sleeve that enables heated thermal control for the un-insulated portion of hydration hose. The sleeve comprises a water-resistant exterior shell; a thermally-insulating interior lining; a micro-controller for providing a temperature control by monitoring the temperatures of the interior lining and the exterior shell and in communication with the micro-controller; a heating element disposed between the interior lining and the exterior shell, and a power source assembly providing power to the micro-controller and to the heating element. The heating element is distributed along the length of the hydration hose and mouthpiece to provide appropriate amounts of heat to mitigate freezing and blockages from forming, and is in communication with the micro-controller which provides activation of the heating element. The micro-controller s operable to regulate the temperature of the sleeve by activating and deactivating the heating element based on temperature reading from a temperature sensor proximate to the heating element.

### BRIEF DESCRIPTION OF THE DRAWINGS

FIG. 1A is an isometric and front view of an electrical heating sleeve on a generic combination backpack and hydration pack FIG. 1B is a wiring schematic of the temperature control circuit and heating circuitry in accordance with the aforementioned sleeve.

### DETAILED DESCRIPTION

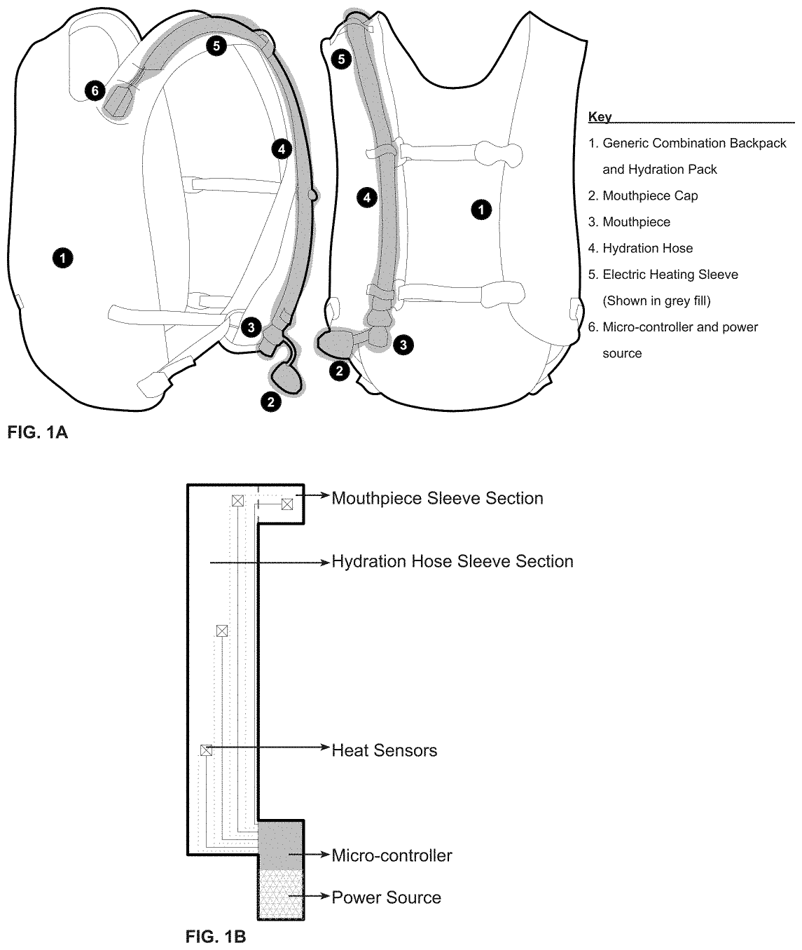

FIG. 1A Depicts an electrical heating sleeve on a generic combination backpack and hydration pack. The construct consists of 5 a integrated heating sleeve and 6 A power source and a micro-controller, A typical cold-weather assembly may be used for the sleeve itself in some constructs, where the sleeve can be made of a waterproof shell and an insulating filler material. Nylon Polyester, or another waterproof and light synthetic fabric, may be used for the sleeve. The power source and micro-controller may be contained within a pack and micro-controller package, which in turn may be contained within a neoprene or nylon pouch in some construct which is connected to the interior of the sleeve. The pouch may be removed in some constructs to allow the sleeve to be washed. As shown in FIG. 1A, the pouch is positioned at the back of the backpack near the connection of the hydration hose to the hydration bag in some constructs. This position may allow one to operate the controls of the device with his or her hands. Alternatively, the controls could be placed near the mouthpiece or anywhere along the length of the sleeve itself. The pocket may have a Velcro closure, or another type of closure.

In some constructs, four to six standard D-cell batteries may be used to power the heating element and a micro controller. The batteries may be enclosed in a battery pack, and the micro-controller package may provide a switch or button that allows the heating circuit to be turned on or off. Other batteries, or power sources including rechargeable batteries, NiCd batteries, or lithium-ion batteries, may be used. Additional battery packs may also be interchangeably provided, so that the sleeve may be continuously operated for a longer period of time. Various rechargeable connections such as USB, Mini USB, PSP, etc. should also be noted and considered.

The micro-controller may be a standard micro-controller, such as an Atmel AVR ATmegal 168 micro-controller, or another micro-controller. The micro-controller is programmed to inter-operate with temperature sensors and to provide zone temperature control functionality. The chosen micro-controller is a low-power 8-bit reduced instruction set computing (RISC) processor that comprises 16 KB flash memory, 1 KB static random-access memory (SRAM), 512 bytes of electrically erasable programmable read-only memory (EEPROM), and an analog-to-digital converter. The micro-controller is programmed to carry out the thermostat functionality described below, as well as a timed auto-shutoff function, intended to prevent one from inadvertently draining the batteries or causing the sleeve to catch fire.

In some constructs, the wires and temperature sensors are embedded within the sleeve, between the inner lining and the outer shell of the sleeve. In some constructs, a fire-retardant filler may be used. All the wires are connected to the micro-controller and power source, and may be connected at a single point via a connector in some constructs. This facilitates the disconnection of the micro-controller and power source for washing of the sleeve.

Controls for adjusting the desired temperature may also be provided. A simple dial or buttons allowing the wearer to adjust a single desired temperature may be used. In some constructs, multiple heating power settings may be provided, allowing one to turn the heating element off, to use a target temperature, or to run the heating elements at maximum power in especially cold environments.

### Temperature Sensors and Heating Elements

FIG. 1B Shows a plurality of temperature sensors [X]. These temperature sensors are allocated to best control the even distribution along the length of the hydration hose and mouthpiece. Each temperature sensor is connected to the processor via insulated copper-signaling wires. Standard inexpensive thermistors may be used for the temperature sensors, such as Omega HSTH-44000 series hermetically sealed thermistor sensor, available from Omega Engineering, Inc. The temperature sensors provide temperature sensing for temperatures in a predetermined range of values. This can be a singular string or multiple strings, as shown in FIG. 1B.

The temperature sensors are positioned inside the sleeve to measure the temperature of the air within the sleeve. This allows the sleeve to shut off heating when the desired temperature inside the sleeve is reached, without regard for the temperature inside the sleeve.

FIG. 1B shows the temperature sensors [X] arranged in zones, or linearly, roughly breaking up the length of the sleeve into equal increments. Although shown with four zones; three along the length of the hydration hose and one near the mouthpiece, temperature zones corresponding to different quadrants could be utilized to simplify or further complicate the system. The micro-controller (grey infill) is connected to each temperature sensor (single black lines) by a signal wire, the signal wires are insulated copper wires intended to be flexible and to conform to the hydration hose's range of movements. Heating elements (dotted lines) which may be carbon fiber wires, are also directed to each temperature zone so that each zone can be independently heated based on the reading of the temperature sensor in that temperature zone. The temperature sensors and associated signal wires, and the heating elements, together make up the temperature zones. One or more carbon fiber wires may be used as a heating element in a particular temperature zone, and these carbon fiber wires may be arranged in a linear, weaving, or any other suitable fashion along the length of the sleeve in some constructs. These carbon fiber wires are also connected to the power supply.

The heating elements may also be individually connected to the power source via a switching arrangement controlled by the micro-controller. When the temperature reading in a temperature zone drops below a set level, the switching arrangement allows electrical current to flow through the heating element in the same temperature zone, which causes the heating element to heat the sleeve in the temperature zone. The set level is controlled by the user via a dial or buttons positioned on the exterior of the micro-controller package. A single temperature setting may be used, in some constructs, to manage the temperature of all temperature zones. This can be sufficient to provide temperature control, as it is possible to provide warmth to cold areas of the sleeve by heating only the specific temperature zones that are below the single temperature setting. In some constructs, the temperature readings for multiple zones may be used to control a heating element in one (or more) of those zones, or the temperature reading from one zone may be used to control (in conjunction with other temperature readings) the heating elements in other zones.

Each temperature zone provides its own temperature feedback loop. The thermistor in a particular temperature zone provides the temperature reading that is used by the microprocessor for determining how much to heat the heating element in that temperature zone. However, in order to stabilize the feedback loop, the temperature reading is performed, in some constructs, a predetermined amount of minutes. Allowing for a delay period allows the heating element to adequately heat the temperature zone before a new temperature reading is performed. These temperature zones allow the hydration hose to remain unobstructed even given uneven temperature and different degrees of heat loss along the length of the sleeve.

Although the present disclosure has been described and illustrated in the foregoing example constructs, it is understood that the present disclosure has been made only by way of example, and that numerous changes in details of implementation of the disclosure may be made without departing from the spirit and scope of the disclosure, which is limited only by the claims that follow. For example, while a single temperature is described, an arbitrary number of temperature settings could by used.

We claim:

1. A heated thermal sleeve for providing temperature control, the sleeve comprising:
A water-resistant exterior shell;
A thermally-insulated interior lining;
A micro-controller for providing temperate zones by monitoring a plurality of temperatures of an interior of the sleeve;
A network of temperature sensors disposed between the interior lining and the exterior shell and in communication with the micro-controller;
A network of heating elements disposed between the interior lining and the exterior shell, the network of heating elements distributed over a plurality of areas of the thermal sleeve, for providing heat to each of the plurality of areas, and in communication with the micro-controller such that the micro-controller provides independent activation of each heating element in the network of heating elements.
Wherein the micro-controller is operable to activate and deactivate each heating element of the network of heating elements based on a temperature reading from a temperature sensor proximate to the heating element.

2. The sleeve of claim 1, further comprising an input device for setting a target temperature.

3. The sleeve of claim 1, further comprising the micro-controller providing temperature zones corresponding to a plurality of zones of the hydrating hose.

4. The sleeve of claim 1, further comprising the micro-controller enabling an auto-shutoff function, wherein each of the heating elements are turned off after a set time.

5. The sleeve of claim 2, wherein the input device is positioned in proximity to an ideal location of the backpack so as to facilitate operation of the input device from the pocket.

6. The sleeve of claim 1, further comprising the micro-controller enabling a maximum heat output function, wherein each of the heating elements are turned on.

7. The sleeve of claim 1, wherein the micro-controller is disposed between the outer shell and the inner lining of the sleeve.

8. The sleeve of claim 1, the heating elements further comprising one or more electrically conductive wires.

9. The sleeve of claim 8, the heating elements further comprising carbon fiber.

10. The sleeve if claim 1, further comprising the temperature sensors and the heating elements being logically grouped into a plurality of temperature zones.

11. The sleeve of claim 10, wherein the temperature zones are each capable of being individually managed by the micro-controller based on a temperature reading in each temperature zone.

12. The sleeve of claim 11, wherein the temperature zones are each capable of being individually managed by the micro-controller based on a plurality of temperature zones.
